(19) United States
(12) Patent Application Publication
(10) Pub. No.: US 2026/0034906 A1
(43) Pub. Date: Feb. 5, 2026

(54) ENCLOSURE STRUCTURE OF CHARGING STATION

(71) Applicant: E-FANER Tech CO., LTD., Taipei City (TW)

(72) Inventors: WEI-JE CHANG, Taipei City (TW); KUO-TSUN LIAO, Taipei City (TW); SHIH -CHIA CHEN, Taipei City (TW)

(21) Appl. No.: 19/280,149

(22) Filed: Jul. 25, 2025

(30) Foreign Application Priority Data
Aug. 1, 2024 (TW) 113208286

(51) Int. Cl. B60L 53/31; B60L 53/30

(52) U.S. Cl. CPC B60L 53/31; B60L 53/305

(57) ABSTRACT

An enclosure structure of a charging station includes a first shell including a first opening, a first accommodation zone being formed inside of the first opening for mounting a first circuit board therein, a first cover plate being attached to the first opening to close the first opening; a second shell including a second opening, a second accommodation zone being formed inside of the second opening for mounting a second circuit board, a second cover plate being attached to the second opening to close the second opening; and at least one hinge mounted between the first and second shells to allow the first and second shells to open or close by means of the hinge.

### BACKGROUND OF THE INVENTION

### (a) Technical Field of the Invention

The present invention relates generally to an enclosure structure of a charging station, and more particularly to a charging station enclosure that is easy to install and maintain and can perfectly enclose a circuit board mounting space.

### (b) Description of the Prior Art

Breakthroughs in battery technology have led to the rise of electric vehicles. More and more vehicle manufacturers are investing in the development of electric vehicles, and more and more consumers are willing to buy electric vehicles as their main means of transportation. In order to facilitate the charging of electric vehicles, charging facilities have been set up one after another, and this has also increased the demand for charging stations.

Most of the charging station structures that are known so far include a first shell and a cover, wherein the first shell includes an opening, and an accommodation zone is formed inside the opening for arrangement of a power circuit, and the cover is locked to the opening of the first shell to close the opening of the first shell, so as to prevent the charging station installed outdoors from being damaged by external forces, having electricity stolen by thieves, or invaded by outdoor insects and snakes to cause internal circuit shorting, thereby ensuring the safety of use of the charging station set up outdoors.

However, in the known charging station structure, the first shell and the cover are separate from each other. When maintenance personnel want to carry out maintenance, they must completely remove the cover. However, the removed cover cannot be properly placed outdoors, and this often causes inconvenience and trouble for maintenance personnel. In addition, the circuit board that is mounted inside the first shell is not properly enclosed, or due to poor sealing, it is easy for water to penetrate or outdoor dust, insects and snakes to invade, causing circuit shorting. Obviously, improvement is necessary.

In view of this, the present invention aims to provide an enclosure structure of a charging station to overcome the deficiency of the prior art.

### SUMMARY OF THE INVENTION

An objective of the present invention is to provide an enclosure structure of a charging station, which comprises: a first shell, which comprises a first opening, wherein a first accommodation zone is formed inside of the first opening for mounting a first circuit board therein, and a side edge of the first shell is at least formed with a through hole for receiving an external power cable to penetrate into the first shell, and a first cover plate is attached to the first opening to close the first opening; a second shell, which comprises a second opening, wherein a second accommodation zone is formed inside of the second opening for mounting a second circuit board, and a second cover plate is attached to the second opening to close the second opening; and at least one hinge, which is mounted between the first and second shells, so that the first and second shells is selectively openable away from each other or closable to and joined to each other by means of the hinge.

In the enclosure structure of the charging station disclosed in the present invention, a gasket layer is further included, surrounding a joined portion of the first and second shells.

In the enclosure structure of the charging station disclosed in the present invention, the first and second shells are fastenable to each other by a plurality of screws after joined to each other.

In the enclosure structure of the charging station disclosed in the present invention, the first circuit board is provided with at least one power wiring seat mounted thereon, and the first cover plate is formed with at least one envelopment pocket, and the envelopment pocket surrounds, in a matching manner, a periphery of the power wiring seat to cover a circumferential gap around the power wiring seat.

In the enclosure structure of the charging station disclosed in the present invention, the hinge comprises: a first bar, which comprises a fixing plate fixed to a side edge of the first shell, a pivot plate being extended from and connected to one side of the fixing plate; a second bar, which comprises a fixing portion fixed to a side edge of the second shell, a connection bar portion extending from and projecting from the fixing portion; a first rocker arm, which has a first end pivotally connected to the pivot plate and a second end pivotally connected to the connection bar portion; and a second rocker arm, which has a first end pivotally connected to the pivot plate and a second end pivotally connected to the connection bar portion, so that the pivot plate, the first and second rocker arms, and the connection bar portion form a four bar linkage mechanism.

In the enclosure structure of the charging station disclosed in the present invention, the second shell is further formed with a window opening, and a display device is fit and mounted in the window opening. The display device comprises a touch display.

In the enclosure structure of the charging station disclosed in the present invention, at least one set of magnetic attraction components is mounted between corresponding inner side of the first cover plate and inner side of the second cover plate, and when the first and second shells are joined, the set of magnetic attraction components are magnetically attracted by each other.

In the enclosure structure of the charging station disclosed in the present invention, a circumference of the first shell is formed as a neck portion, and a blocking wall protrudes from at least one side of the neck portion for winding an electrical cord of a charging gun on the neck portion.

In the enclosure structure of the charging station disclosed in the present invention, the second cover plate is at least formed with a plug hole to correspond to a signal terminal of the second circuit board.

In the enclosure structure of the charging station disclosed in the present invention, he first circuit board is provided with at least one power wiring seat mounted thereon, and the power wiring seat comprises a plurality of wiring holes, and each of the wiring holes is in a different color to distinguish the electrical properties of power lines connected thereto.

In the enclosure structure of the charging station disclosed in the present invention, the first circuit board is provided with at least one power wiring seat mounted thereon, and the power wiring seat comprises a plurality of wiring holes, and each of the wiring holes is provided with a different symbol or text marked on a periphery thereof to distinguish the electrical properties of power lines connected thereto.

### BRIEF DESCRIPTION OF THE DRAWINGS

FIG. 1 is an exploded view showing the present invention.

FIG. 2 is an exploded view showing a hinge of the present invention.

FIG. 3 is a perspective view showing the hinge of the present invention in an assembled form.

FIG. 4 is a top plan view showing the hinge of the present invention.

FIG. 5 is a perspective view showing the present invention in an assembled form.

FIG. 6 is a perspective view, taken from a different viewing angle, showing a first shell of the present invention.

FIG. 7 is a top plan view showing operation of the present invention for mating and closing first and second shells.

FIG. 8 is a top plan view showing the present invention before first and second shells are completely mating and closing together.

FIG. 9 is a top plan view showing the first and second shells completely mating and closing together subsequent to FIG. 8.

FIG. 10 is a perspective view showing the present invention after the first and second shells are completely mating and closing together.

FIG. 11 is a cross-sectional view taken along line A-A of FIG. 10.

FIG. 12 is a perspective view showing a state of application of the present invention.

### DETAILED DESCRIPTION OF THE PREFERRED EMBODIMENTS

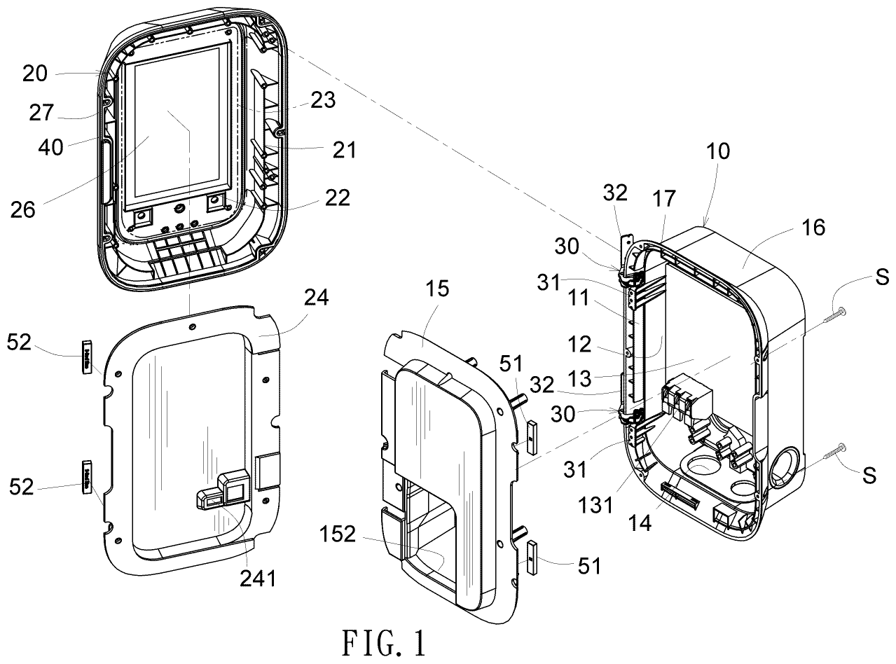

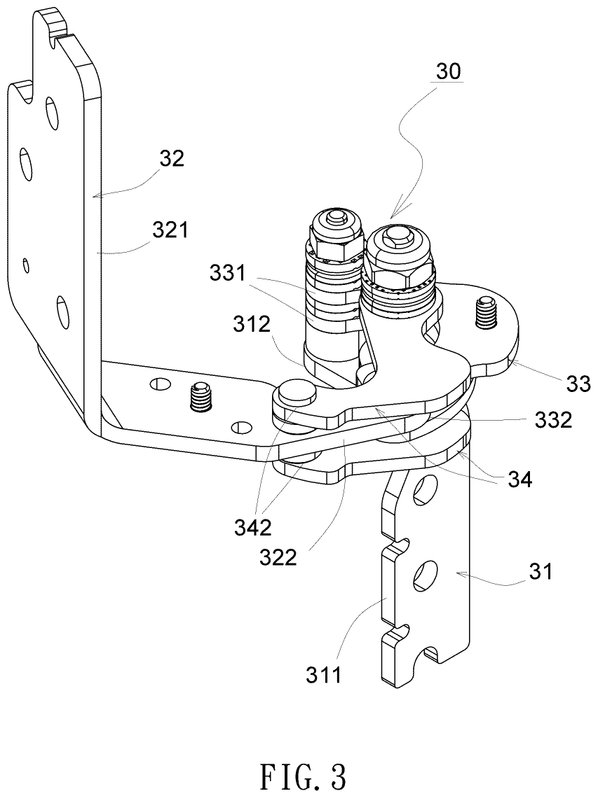

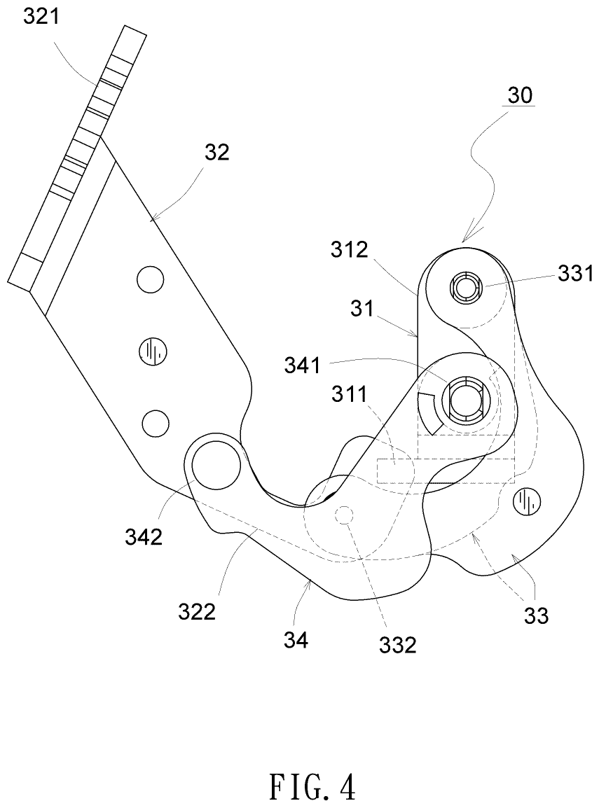

Referring to FIGS. 1-12, the present invention relates to an enclosure structure of a charging station and comprises: a first shell (10), which comprises a first opening (11), wherein a first accommodation zone (12) is formed inside of the first opening (11) for mounting a first circuit board (13) therein, and a side edge of the first shell (10) is at least formed with a through hole (14) for receiving an external power cable to penetrate into the first shell (10), and a first cover plate (15) is attached to the first opening (11) to close the first opening (11); a second shell (20), which comprises a second opening (21), wherein a second accommodation zone (22) is formed inside of the second opening (21) for mounting a second circuit board (23), and a second cover plate (24) is attached to the second opening (21) to close the second opening (21); and at least one hinge (30), which is mounted between the first and second shells (10, 20) so that the first and second shells (10, 20) can be lifted and opened or mated and joined together by means of the hinge (30).

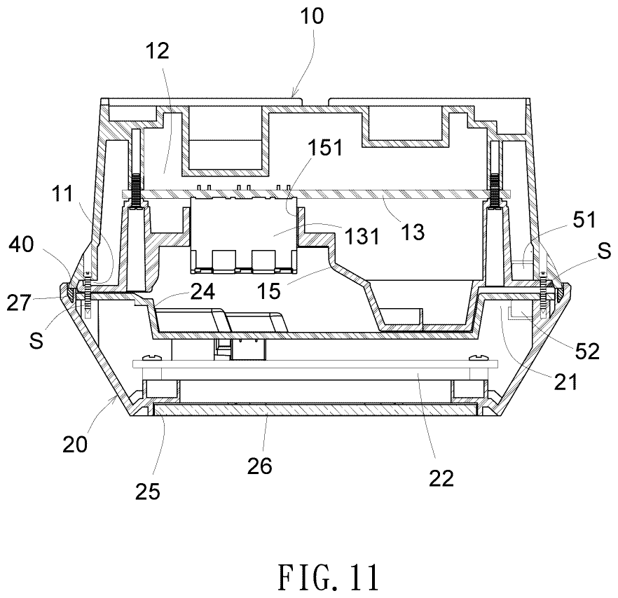

As shown in FIGS. 1 and 11, in the enclosure structure of the charging station disclosed in the present invention, the first circuit board (13) is enclosed in the first accommodation zone (12) by the first cover plate (15); and the second circuit board (23) is enclosed in the second accommodation zone (22) by the second cover plate (24), so that shorting occurring in the first and second circuit boards (13, 23) caused by external insects or snakes invading into the first and second accommodation zones (12, 22) can be effectively prevented to thereby improve the safety of the charging station set up outdoors.

As shown in FIGS. 1 and 11, the enclosure structure of the charging station disclosed in the present invention may further comprise a gasket layer (40) surrounding the mated and joined site of the first and second shells (10, 20), so as to effectively prevent outdoor rainwater or insects from invading into the first and second shells (10, 20) after the first and second shells (10, 20) are mated and joined. The gasket layer (40) can be inserted in an insertion groove (27) along a circumference of the first shell (10) or the second shell (20), and can also be attachable by adhesives to the circumferences of the first and second shells (10, 20), and the present invention is not limited thereto. The gasket layer (40) can be made of rubber, silicone, or other materials, and the present invention is not limited thereto.

As shown in FIG. 1, in the enclosure structure of the charging station disclosed in the present invention, when the first and second shells (10, 20) are mated and joined to each other, a plurality of screws (S) may be applied to fasten the first and second shells (10, 20) together to ensure that the first and second shells (10, 20) are tightly closed and sealed, and to make the present invention in compliance with relevant regulations for outdoor installation.

As shown in FIGS. 1, 5, and 6, in the enclosure structure of the charging station disclosed in the present invention, the first circuit board (13) is provided with at least one power wiring seat (131) mounted thereon, and the first cover plate (15) is formed with at least one envelopment pocket (151), wherein the envelopment pocket (151) surrounds, in a matching manner, the periphery of the power wiring seat (131) to cover a circumferential gap around the power wiring seat (131) to prevent outdoors insects and snakes from penetrating through the circumferential gap of the power wiring seat (131) to get into the first accommodation zone (12) and causing shorting and damage of the first circuit board (13), thereby improving the safety of the charging station set up outdoors. Further, the first cover plate (15) may be formed with a fitting hole (152) penetrating therethrough to fit onto the through hole (14) of the first shell (10), so as to allow the external power cable to penetrate through the first shell (10) and the first cover plate (15) to connect to the power wiring seat (131).

As shown in FIGS. 1-4, in the enclosure structure of the charging station disclosed in the present invention, the hinge (30) comprises: a first bar (31), which comprises a fixing plate (311) fixed to a side edge of the first shell (10), a pivot plate (312) being extended from and connected to one side of the fixing plate (311); a second bar (32), which comprises a fixing portion (321) fixed to a side edge of the second shell (20), a connection bar portion (322) extending from and projecting from the fixing portion (321); a first rocker arm (33), which has a first end (331) pivotally connected to the pivot plate (312) and a second end (332) pivotally connected to the connection bar portion (322); and a second rocker arm (34), which has a first end (341) pivotally connected to the pivot plate (312) and a second end (342) pivotally connected to the connection bar portion (322), so that the pivot plate (312), the first and second rocker arms (33, 34), and the connection bar portion (322) form a four bar linkage mechanism.

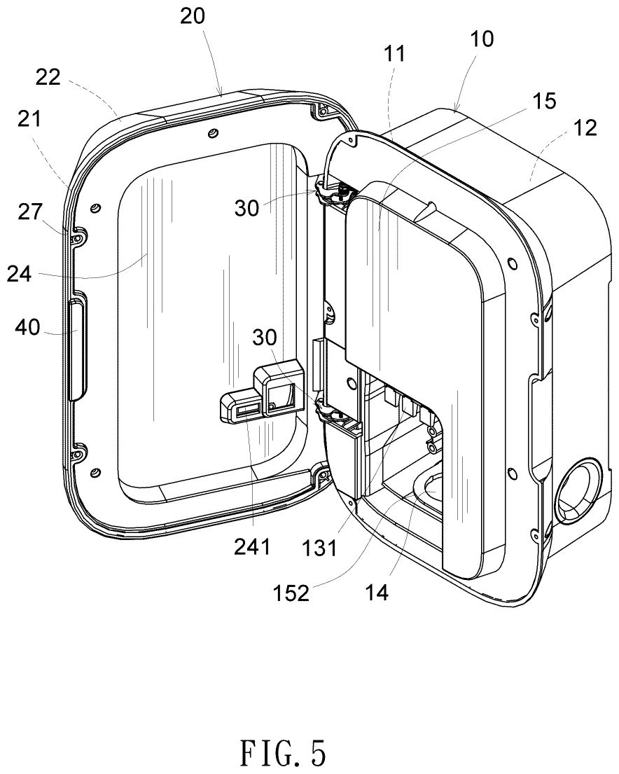

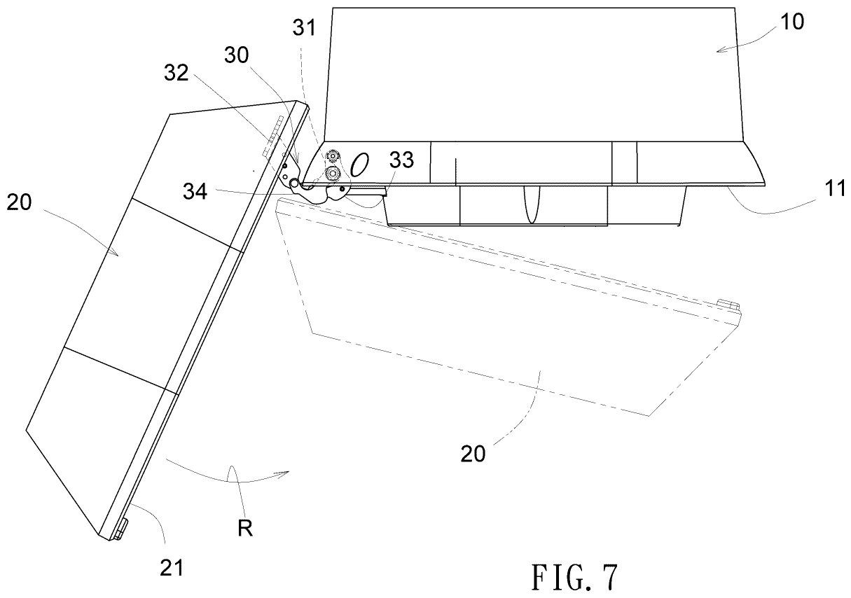

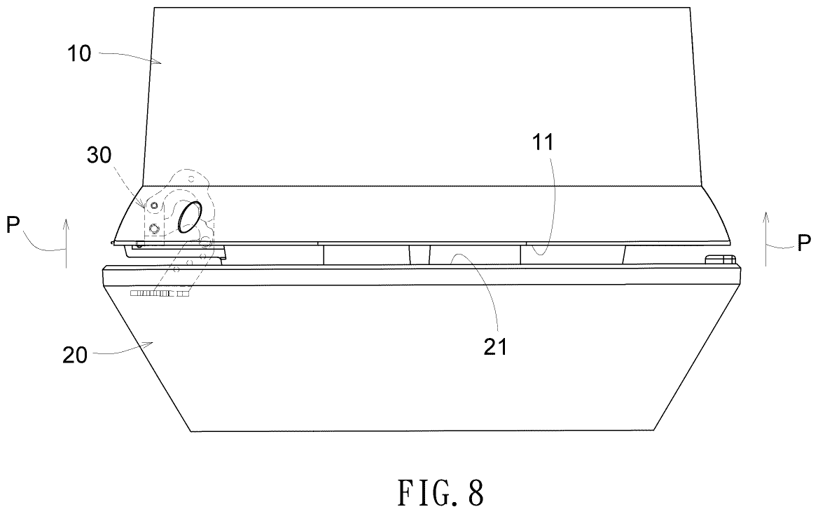

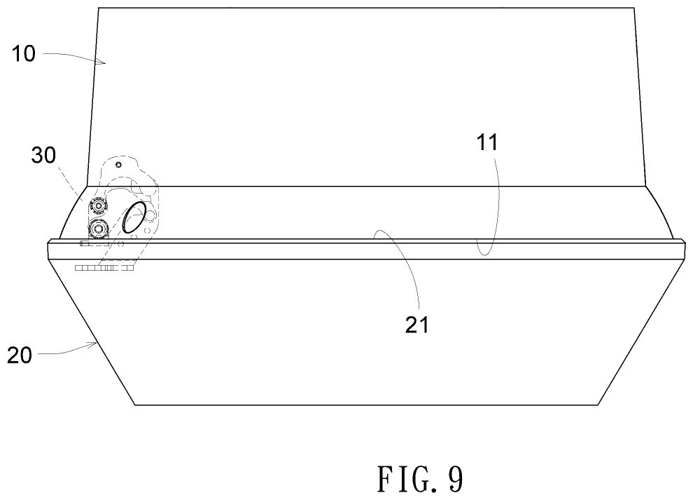

As shown in FIGS. 1-4, in the enclosure structure of the charging station disclosed in the present invention, the hinge (30) in which the four bar linkage mechanism is implemented comprises four rotational axes, and the second bar (32) can adjust the angle of the second shell (20) connected thereto by following the swinging of the first and second rocker arms (33, 34), and can stably hold the second shell (20), after outward opening thereof, at one side of the first shell (10), as shown in FIG. 5, so that maintenance personnel can carry out service and maintenance on the charging station without completely removing the second shell (20). Further, as shown in FIG. 7, when the second shell (20) is rotated, in the R direction, toward and thus closed onto the first shell (10), before the first and second shells (10, 20) are completely closed on each other, as shown in FIG. 8, the hinge (30) can be operated to adjust a pressing angle of the second shell (20), so that after the second shell (20) is adjusted to a position parallel to the first shell (10), as shown in FIG. 8, the second shell (20) can be moving and pressing in the P direction to allow the second shell (20) of the present invention to be pressed toward and closed onto the first shell (10) in a manner of being close to a state of being parallel thereto, as shown in FIG. 9. Therefore, the compressive stress around the periphery of the first and second shells (10, 20), after being locked, will be extremely uniform, and an effect of optimum sealing and closure is achieved to prevent a phenomenon that the first and second shells (10, 20) warp toward one side after being closed together. As such, in the enclosure structure of the charging station disclosed in the present invention, the first and second shells (10, 20), after being mated and joined together, exhibit extreme tightness along the periphery thereof to effectively prevent rainwater from invading therethrough.

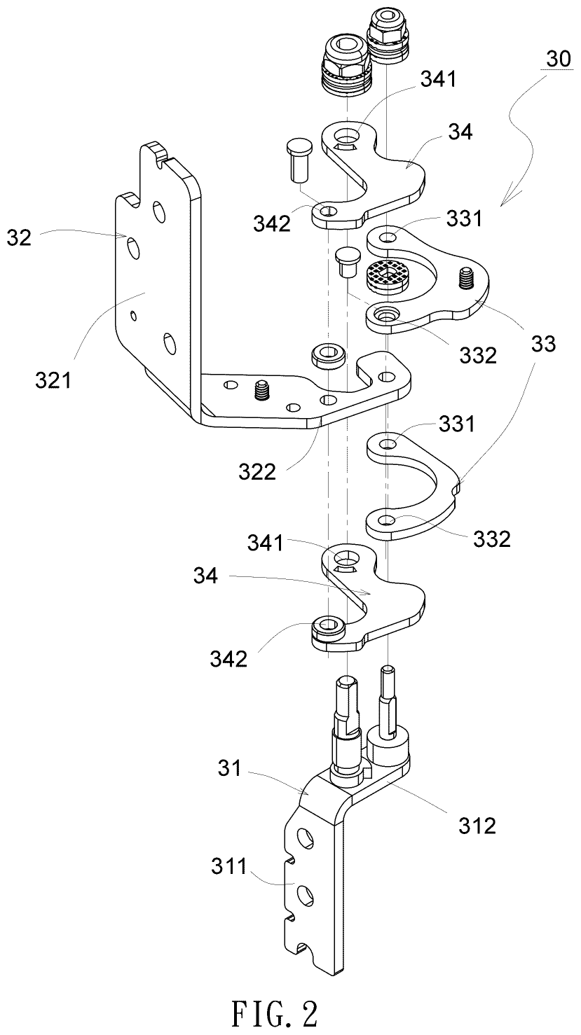

In the enclosure structure of the charging station disclosed in the present invention, in addition to the use of the four bar linkage type hinge (30) shown in FIGS. 2-4, hinges that are commonly used in the art can also be used, for modification, and the present invention is not limited to this.

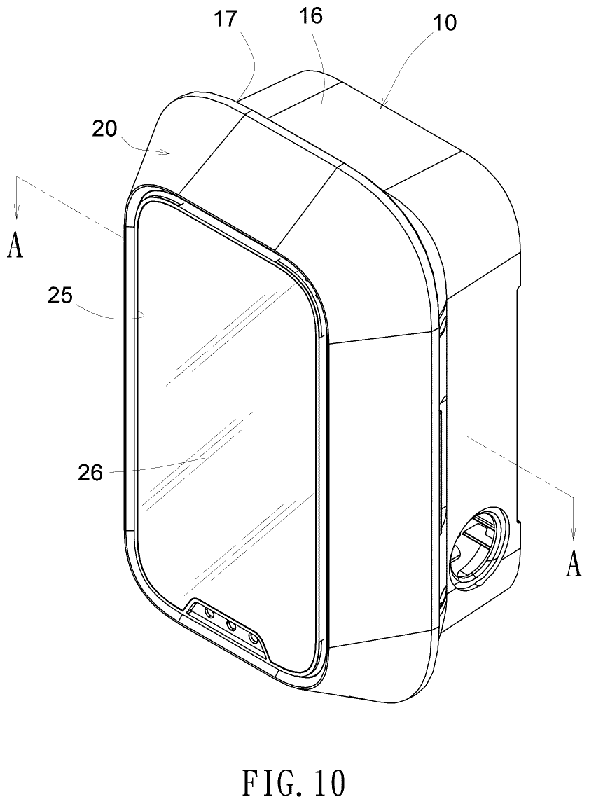

As shown in FIG. 10, in the enclosure structure of the charging station disclosed in the present invention, an outside surface of the second shell (20) is further provided with a window opening (25), and a display device (26) is fit and mounted in the window opening (25) for displaying the current charging state and information of the charging station. The display device (26) can be a touch display, and a user may use the touch display to input instructions or information, such as inputting the user's personal information, charging options, and payment methods.

As shown in FIGS. 1 and 11, in the enclosure structure of the charging station disclosed in the present invention, at least one set of magnetic attraction components (51, 52) is mounted on corresponding portions of the first shell (10) and the second shell (20), and when the first and second shells (10, 20) are mated and joined to each other, the set of magnetic attraction components (51, 52) are magnetically attracted by each other, so that when the first and second shells (10, 20) are approaching to each other for mutual mating and joining together, the mating and joining can be automatically completed by the magnetic attraction of each set of magnetic attraction components (51, 52), and at this moment, the maintenance personnel can feel that the first and second shells (10, 20) are completely mated and joined, and also, the sealing effect of the first and second shells (10, 20) is also enhanced. The set of magnetic attraction components (51, 52) can be mounted on the inner side of the first cover plate (15) and the inner side of the second cover plate (24), but the present invention is not limited thereto.

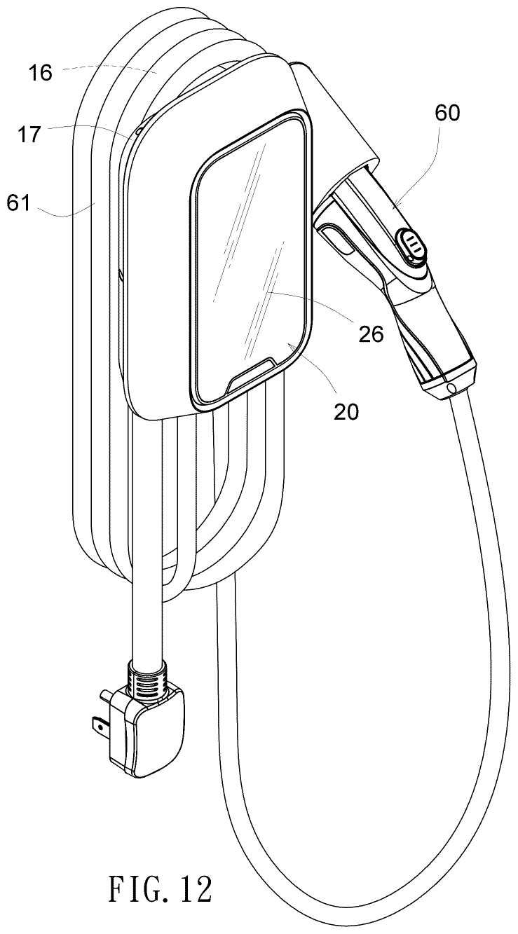

As shown in FIGS. 11 and 12, in the enclosure structure of the charging station disclosed in the present invention, the circumference of the first shell (10) is formed as a neck portion (16), and a blocking wall (17) protrudes from at least one side of the neck portion (16), and the user can wind an electrical cord (61) of a charging gun (60) around the neck portion (16), while the blocking wall (17) can block the electrical cord (61) from falling outwards, so that the charging station disclosed in the present invention also has the function of cable arrangement.

As shown in FIGS. 1 and 5, in the enclosure structure of the charging station disclosed in the present invention, the second cover plate (24) is at least formed with a plug hole (241) to correspond to a signal terminal (not shown) of the second circuit board (23) in order to allow a signal line plugged therein to get in signal connection with the second circuit board (23).

As shown in FIGS. 1, 5, and 6, in the enclosure structure of the charging station disclosed in the present invention, the first circuit board (13) is provided with at least one power wiring seat (131) mounted thereon, and the power wiring seat (131) comprises a plurality of wiring holes (131a, 131b, 131c), and each of the wiring holes (131a, 131b, 131c) is in a different color to distinguish the electrical properties of power lines connected thereto. For example, red indicates that the wiring hole (131a) is used to connect a live line of a power source; black indicates that the wiring hole (131b) is used to connect a neutral line of a power source; and green indicates that the wiring hole (131c) is used to connect a ground line of a power source, so that an assembler can perform wiring operations according to the colors to avoid wiring errors. However, the present invention is not limited to a color system of such colors.

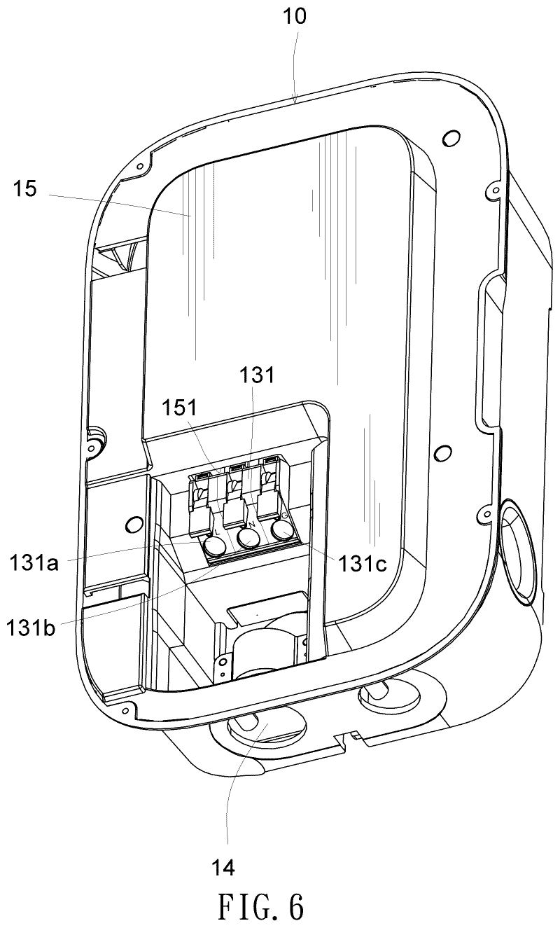

As shown in FIGS. 1 and 6, in the enclosure structure of the charging station disclosed in the present invention, the first circuit board (13) is provided with at least one power wiring seat (131) mounted thereon, and the power wiring seat (131) comprises a plurality of a wiring holes (131a, 131b, 131c), and each of wiring holes (131a, 131b, 131c) is provided with a different symbol or text marked on a periphery thereof to distinguish the electrical properties of power lines connected thereto. For example, “L” indicates that the wiring hole (131a) is used to connect the live wire of a power source; “N” indicates that the wiring hole (131b) is used to connect the neutral wire of a power source; and “G” indicates that the wiring hole (131c) is used to connect the ground wire of a power source. An assembler can perform wiring operations by using the text or symbol around each wiring hole (131a, 131b, 131c) to avoid wiring errors. However, the present invention is not limited to the content or form of such texts or symbols.

I claim:

1. An enclosure structure of a charging station, comprising:
a first shell, which comprises a first opening, wherein a first accommodation zone is formed inside of the first opening for mounting a first circuit board therein, and a side edge of the first shell is at least formed with a through hole for receiving an external power cable to penetrate into the first shell, and a first cover plate is attached to the first opening to close the first opening;
a second shell, which comprises a second opening, wherein a second accommodation zone is formed inside of the second opening for mounting a second circuit board, and a second cover plate is attached to the second opening to close the second opening; and
at least one hinge, which is mounted between the first and second shells, so that the first and second shells is selectively openable away from each other or closable to and joined to each other by means of the hinge.

2. The enclosure structure of the charging station according to claim 1, further comprising a gasket layer surrounding a joined portion of the first and second shells.

3. The enclosure structure of the charging station according to claim 2, wherein the gasket layer is inserted in an insertion groove along a circumference of the first shell or the second shell.

4. The enclosure structure of the charging station according to claim 1, wherein the first and second shells are fastenable to each other by a plurality of screws after joined to each other.

5. The enclosure structure of the charging station according to claim 1, wherein the first circuit board is provided with at least one power wiring seat mounted thereon, and the first cover plate is formed with at least one envelopment pocket, and the envelopment pocket surrounds, in a matching manner, a periphery of the power wiring seat to cover a circumferential gap around the power wiring seat.

6. The enclosure structure of the charging station according to claim 1, wherein the hinge comprises: a first bar, which comprises a fixing plate fixed to a side edge of the first shell, a pivot plate being extended from and connected to one side of the fixing plate; a second bar, which comprises a fixing portion fixed to a side edge of the second shell, a connection bar portion extending from and projecting from the fixing portion; a first rocker arm, which has a first end pivotally connected to the pivot plate and a second end pivotally connected to the connection bar portion; and a second rocker arm, which has a first end pivotally connected to the pivot plate and a second end pivotally connected to the connection bar portion.

7. The enclosure structure of the charging station according to claim 1, wherein the second shell is further formed with a window opening, and a display device is fit and mounted in the window opening.

8. The enclosure structure of the charging station according to claim 7, wherein the display device comprises a touch display.

9. The enclosure structure of the charging station according to claim 1, wherein at least one set of magnetic attraction components is mounted on corresponding portions of the first shell and the second shell, and when the first and second shells are joined, the set of magnetic attraction components are magnetically attracted by each other.

10. The enclosure structure of the charging station according to claim 1, wherein a circumference of the first shell is formed as a neck portion, and a blocking wall protrudes from at least one side of the neck portion to allow an electrical cord of a charging gun to be wound around the neck portion.

11. The enclosure structure of the charging station according to claim 1, wherein the second cover plate is at least formed with a plug hole to correspond to a signal terminal of the second circuit board.

12. The enclosure structure of the charging station according to claim 1, wherein the first circuit board is provided with at least one power wiring seat mounted thereon, and the power wiring seat comprises a plurality of wiring holes, and each of the wiring holes is in a different color to distinguish the electrical properties of power lines connected thereto.

13. The enclosure structure of the charging station according to claim 1, wherein the first circuit board is provided with at least one power wiring seat mounted thereon, and the power wiring seat comprises a plurality of wiring holes, and each of the wiring holes is provided with a different symbol or text marked on a periphery thereof to distinguish the electrical properties of power lines connected thereto.

14. The enclosure structure of the charging station according to claim 12, wherein the first cover plate is further formed with a fitting hole penetrating therethrough to fit onto a periphery of the through hole of the first shell so as to allow the external power cable to penetrate through the first shell and the first cover plate to connect to the power wiring seat.

15. The enclosure structure of the charging station according to claim 13, wherein the first cover plate is further formed with a fitting hole penetrating therethrough to fit onto a periphery of the through hole of the first shell so as to allow the external power cable to penetrate through the first shell and the first cover plate to connect to the power wiring seat.
